(19) United States
(12) Patent Application Publication
(10) Pub. No.: US 2025/0190767 A1
(43) Pub. Date: Jun. 12, 2025

(54) APPARATUS AND METHOD FOR CALIBRATING CONFIDENCE OF ARTIFICIAL NEURAL NETWORK

(71) Applicant: UIF (University Industry Foundation), Yonsei University, Seoul (KR)

(72) Inventors: Bum Sub HAM, Seoul (KR); Hye Kang PARK, Seoul (KR); Jong Youn NOH, Seoul (KR); Young Min OH, Seoul (KR); Dong Hyeon BAEK, Seoul (KR)

(21) Appl. No.: 18/952,437

(22) Filed: Nov. 19, 2024

(30) Foreign Application Priority Data
Dec. 12, 2023 (KR) 10-2023-0178447

(51) Int. Cl. G06N 3/047; G06N 3/084

(52) U.S. Cl. CPC G06N 3/047; G06N 3/084

(57) ABSTRACT

An apparatus for calibrating confidence determines a correct logit element and a false logit element among a plurality of logit elements of a logit vector obtained by a neural network model performing a neural network operation on the training data, based on a correct class and a false class determined from a target probability distribution including target probabilities for each of a plurality of classes according to ground truth of the training data as elements, and determines whether to calibrate and a calibration value for a plurality of target probabilities of the target probability distribution based on a difference in value between the correct logit element and the false logit element.

### CROSS-REFERENCE TO RELATED APPLICATIONS

This application claims priority under 35 U.S.C. § 119 (a) to Korean Patent Application No. 10-2023-0178447, filed on Dec. 11, 2023, with the Korean Intellectual Property Office, the disclosure of which is incorporated herein in its entirety by reference.

### BACKGROUND

### 1. Technical Field

The present disclosure relates to an apparatus and method for calibrating confidence of an artificial neural network, and more particularly, to an apparatus and method for calibrating confidence based on adaptive conditional label smoothing.

### 2. Description of the Related Art

Currently, artificial neural networks are widely used in various applications such as image processing, speech recognition, and text-to-speech conversion.

FIG. 1 is a diagram for explaining the operation of an image recognition neural network.

In FIG. 1, as an example of various artificial neural networks, the operation of an image recognition network is illustrated. As illustrated in FIG. 1, the image recognition neural network encodes an input image to obtain a logit vector z, and inputs the obtained logit vector z into a softmax function-based layer to obtain a probability vector p. Here, when the number of total classes (c) is C, the logit vector z and the probability vector p for one input image are each C-dimensional, and the image recognition network estimates the class (c) with the largest value in the probability vector p as the class of the input image (argmax p), and the probability value for the estimated class is called the confidence value.

As such, when an artificial neural network is actually applied, decisions are made based on the confidence value, so the network must output an accurate confidence value. For example, if the confidence value for the class (c) estimated by the image recognition neural network is 0.9, it should mean that the input image is the class (c) estimated with a 90% probability.

In addition, the network outputs accurate confidence values, it is easy to decide whether to follow the network's predictions based on the confidence values in real situations. In other words, a reliable artificial neural network model should have matching prediction accuracy and confidence for the input.

However, most current image recognition networks using deep learning suffer from the problem of overconfident prediction, where the confidence value is too large compared to the accuracy. This is because the softmax cross entropy loss Lee is used in the process of training the network.

FIG. 2 is a diagram for explaining overconfident prediction according to learning using cross entropy loss.

Currently, when training an image recognition network, learning is mostly performed using the distribution of one-hot labels in the dimension C, where the probability (qⱼ, j=y) for the correct class (here, y as an example) labeled as the ground truth is set to 1, and the probability (qⱼ, j≠y) for the remaining false classes is set to 0, as the target probability distribution q.

In addition, as shown in FIG. 2, the softmax cross entropy loss L_{ce} learns to make each element of the probability vector p, i.e., each class-wise estimated probability (pⱼ), follow each element of the one-hot label q, i.e., the class-wise target probability (qⱼ).

At this time, the cross entropy loss L_{ce} can be calculated according to Equation 1.

$${ℒ}_{CE} = {𝔼}_{q} [ p ] = - {\sum }_{k = 1}^{c} {q}_{k} log {p}_{k} \qquad [ Equation 1 ]$$

(wherein, [symbol] _{q}[p] represents the cross entropy of the probability vector p for the target probability distribution q.)

In Equation 1, the class-wise estimated probability (pⱼ) of the probability vector p according to the element zⱼ of the logit vector z is expressed as Equation 2.

$${p}_{j} = \frac{exp ( {z}_{j} )}{{\sum }_{k = 1}^{C} exp ( {z}_{k} )} \qquad [ Equation 2 ]$$

In addition, the gradient of the cross entropy loss L_{ce} for backpropagation during learning can be calculated using Equation 3.

$$\frac{\partial {ℒ}_{CE}}{\partial {z}_{j}} = {p}_{j} - {q}_{j} \qquad [ Equation 3 ]$$

In other words, training is performed so that the class-wise estimated probability (pⱼ) of the probability vector p and the class-wise target probability (qⱼ) of the target probability distribution q become the same (pⱼ−qⱼ=0).

In this process, the softmax cross entropy loss L_{ce} learns to make the correct class estimate probability (p_{y}) for the correct class reach 1, which is the correct class target probability q_{y} in the target probability distribution q, but the correct class estimate probability (p_{y}) cannot reach 1, which is the correct class target probability q_{y}. Therefore, the correct class estimate probability (p_{y}) is learned to continuously increase. On the other hand, the false class estimate probability (pⱼ, j≠y) for the false class is learned to continuously decrease by following the false class target probability (qⱼ, j≠y) in the target probability distribution q. This causes the artificial neural network to overfit and make overconfident predictions.

### SUMMARY OF THE INVENTION

An object of the present disclosure is to provide an apparatus and method for calibrating confidence, capable of preventing overconfident prediction problems by calibrating target probabilities for the correct class and false class of a target probability distribution according to a one-hot label so as to be smoothed.

Another object of the present disclosure is to provide an apparatus and method for calibrating confidence, capable of performing adaptive conditional smoothing for a target probability distribution by providing a smoothing function that adjusts the level of smoothing of a target probability distribution and an indicator function that determines whether to smooth or not, and applying the provided smoothing function and indicator function.

According to one embodiment of the present disclosure, an apparatus for calibrating confidence includes: a memory; and a processor that executes at least a part of an operation according to a program stored in the memory, wherein the processor determines a correct logit element and a false logit element among a plurality of logit elements of a logit vector obtained by a neural network model performing a neural network operation on the training data, based on a correct class and a false class determined from a target probability distribution including target probabilities for each of a plurality of classes according to ground truth of the training data as elements, and determines whether to calibrate and a calibration value for a plurality of target probabilities of the target probability distribution based on a difference in value between the correct logit element and the false logit element.

The processor may perform calibration for the correct class when the value obtained by subtracting the value of the false logit element having the minimum value among the remaining false logit elements from the value of the correct logit element is greater than or equal to the margin value.

The processor may perform calibration for the false logit element when the value obtained by subtracting the value of each false logit element from the value of the correct logit element for the false class is greater than or equal to the margin value.

The processor may obtain a correct calibration value by weighting the difference value, obtained by subtracting the margin value and the false logit element having the minimum value among the remaining false logit elements from the value of the correct logit element for the correct class, with a first weight.

The processor may perform calibration, when it is determined that calibration is being performed for a correct class, by subtracting the correct calibration value determined from the correct target probability among a plurality of target probabilities of the target probability distribution.

The processor may obtain a false calibration value by weighting the difference value obtained by subtracting the value of each false logit element and the margin value from the value of the correct logit element, for the false class, with a second weight.

The processor may perform calibration, when it is determined that calibration is being performed for a false class, by adding a false calibration value determined from a false target probability among a plurality of target probabilities of the target probability distribution.

The processor may calculate the gradient of the loss for training the neural network model by weighting the calculated difference value with a first weight, when the difference value, obtained by subtracting the margin value and the value of the false logit element having the minimum value among the remaining false logit elements from the value of the correct logit element, for the correct class, is a positive value.

The processor may calculate the gradient of the loss for training the neural network model by weighting the calculated difference value with a negative second weight, when the difference value, obtained by subtracting the margin value and the value of each false logit element from the value of the correct logit element, for the false class, is a positive value.

The target probability distribution may be configured in a one-hot label format where the target probability for the correct class has a probability value of 1 and the target probability for the false class has a probability value of 0.

According to another embodiment of the present disclosure, a method for calibrating confidence is performed by a processor, the method comprising the steps of: determining a correct logit element and a false logit element among a plurality of logit elements of a logit vector obtained by a neural network model performing a neural network operation on the training data, based on a correct class and a false class determined from a target probability distribution including target probabilities for each of a plurality of classes according to ground truth of the training data as elements; and determining whether to calibrate and a calibration value for a plurality of target probabilities of the target probability distribution based on a difference in value between the correct logit element and the false logit element.

The apparatus and method for calibrating confidence of the present disclosure provide a smoothing function for adjusting the level of smoothing and an indicator function for determining whether to smooth, and apply the provided smoothing function and the indicator function during learning to smooth the target probability for the correct class and the false class of the target probability distribution according to the one-hot label, thereby preventing the occurrence of an overconfident prediction problem.

### BRIEF DESCRIPTION OF THE DRAWINGS

FIG. 1 is a diagram for explaining the operation of an image recognition neural network.

FIG. 2 is a diagram for explaining overconfident prediction according to learning using cross entropy loss.

FIG. 3 shows an example of class-wise estimated probabilities of a probability vector obtained from a neural network module.

FIG. 4 shows an example of class-wise target probabilities of a target probability distribution according to a one-hot label generated based on ground truth labeled in training data.

FIGS. 5 to 7 are drawings for explaining techniques for calibrating confidence, respectively.

FIG. 8 shows a schematic configuration of a training device for a neural network model including an apparatus for calibrating confidence according to one embodiment.

FIG. 9 shows a method for calibrating confidence according to one embodiment.

FIG. 10 is a drawing for explaining a computing environment including a computing device according to one embodiment.

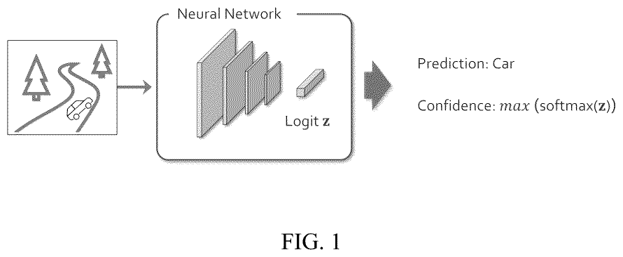

### DETAILED DESCRIPTION OF THE INVENTION

Hereinafter, specific embodiments according to the embodiments of the present disclosure will be described with reference to the drawings. The following detailed description is provided to assist in a comprehensive understanding of the methods, devices and/or systems described herein. However, this is only an example and the present invention is not limited thereto.

In describing the embodiments of the present disclosure, when it is determined that detailed descriptions of known technology related to the present disclosure may unnecessarily obscure the gist of the embodiments, the detailed descriptions thereof will be omitted. The terms used below are defined in consideration of functions in the present disclosure, but may be changed depending on the customary practice or the intention of a user or operator. Thus, the definitions should be determined based on the overall content of the present specification. The terms used herein are only for describing the embodiments, and should not be construed as limitative. Unless the context clearly indicates otherwise, the singular forms are intended to include the plural forms as well. It should be understood that the terms “comprises,” “comprising,” “includes,” and “including,” when used herein, specify the presence of stated features, numerals, steps, operations, elements, or combinations thereof, but do not preclude the presence or addition of one or more other features, numerals, steps, operations, elements, or combinations thereof. In addition, terms such as “ . . . unit”, “ . . . er/or”, “module” and “block” described in the specification means a unit for processing at least one function or operation, which may be implemented by hardware or software or a combination of hardware and software.

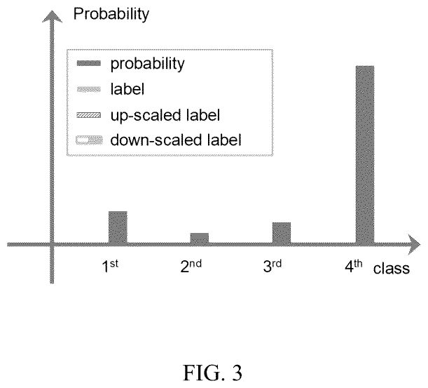

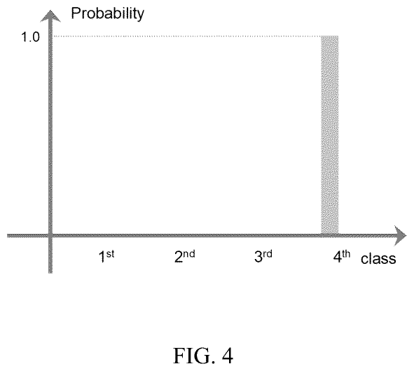

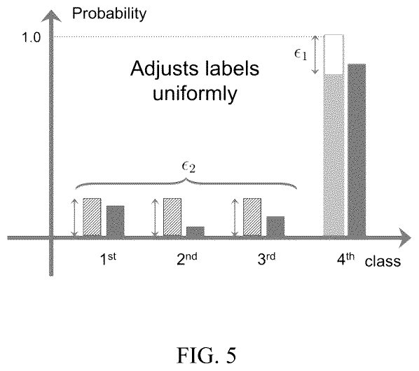

FIG. 3 shows an example of class-wise estimated probabilities of a probability vector obtained from a neural network module, and FIG. 4 shows an example of class-wise target probabilities of a target probability distribution according to a one-hot label generated based on ground truth labeled in training data. In addition, FIGS. 5 to 7 are drawings for explaining techniques for calibrating confidence, respectively.

FIG. 3 illustrates the class-wise estimated probability (pⱼ) of the probability vector p for four classes as an example, and FIG. 4 illustrates the four class-wise target probabilities (qⱼ) of the target probability distribution q corresponding to each class-wise estimated probability (pⱼ) of the probability vector p of FIG. 3. As illustrated in FIG. 4, here, the 4th class has a probability value of 1 as the correct class target probability (q_{y}, y=j=4), and the remaining 1^{st} to 3^{rd} classes have a probability value of 0 as the false class target probability (qⱼ, j≠y).

Confidence calibration refers to a technique of smoothing the correct class target probability q_{y} and the false class target probability (qⱼ, j≠y) in the target probability distribution q to prevent the occurrence of the above-mentioned overconfident prediction problem.

Various smoothing techniques may be considered. FIGS. 5 to 7 illustrate a label smoothing technique, an adaptive smoothing technique, and a conditional smoothing technique, respectively, and illustrate comparisons of the calibrated class-wise target probability (q′ⱼ) of the calibrated target probability distribution (q′), obtained by smoothing the class-wise target probability (qⱼ) of the target probability distribution q illustrated in FIG. 4, with the class-wise estimated probability (pⱼ).

First, the label smoothing technique illustrated in FIG. 5 is a technique for uniformly calibrating the class-wise target probabilities (qⱼ) of the target probability distribution q of FIG. 4, as in (c), regardless of the probability vector p illustrated in (a) of FIG. 3. In the label smoothing technique, among the class-wise target probabilities (qⱼ) of the target probability distribution q, the correct class target probability (q_{y}) having a probability value of 1 may be decreased by a specified first calibration value (&1, for example, ε₁=0.1), while the false class target probability (qⱼ, j≠y) having a probability value of 0 may be increased by a specified second calibration value (82, for example, ε₂=0.15). In this way, by calibrating the correct class target probability (qv) and the false class target probability (qⱼ, j≠y) to the calibrated correct class target probability (q′_{y}) and the calibrated false class target probability (q′ⱼ), the calibrated target probability distribution (q′) can be obtained.

That is, each probability value is calibrated by a pre-specified value so that the difference in probability value is reduced between the correct class target probability (q_{y}) and the false class target probability (qⱼ, j≠y) in the target probability distribution q.

This label smoothing technique has the advantage of being the simplest method and can solve the overconfident prediction problem to some extent, but it smooths the class-wise target probability (qⱼ) of the target probability distribution q regardless of the correct class estimate probability (p_{y}) and the false class estimate probability (pⱼ, j≠y) of the probability vector p, so the learning efficiency may be reduced. In particular, even if the correct class target probability (q_{y}) is calibrated to a probability value less than 1, the correct class target probability (q_{y}) required in an actual artificial neural network may be lower than the calibrated probability value in some cases, and conversely, the false class target probability (qⱼ) may be higher than the calibrated probability value in some cases. Therefore, when applying the label smoothing technique, the neural network model may not exhibit the required performance depending on the set first and second calibration values (ε₁, ε₂).

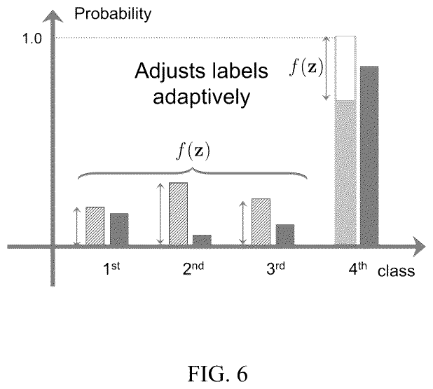

Meanwhile, the adaptive smoothing technique illustrated in FIG. 6 is a technique that performs smoothing by considering not only the target probability distribution q but also the probability vector p, unlike the label smoothing technique of FIG. 5. The adaptive smoothing technique can also perform calibrations for the correct class and the false class differently. Referring to FIG. 6, in the adaptive smoothing technique, calibration is performed so that the larger the probability value of the correct class estimate probability (p_{y}) in the probability vector p, the greater the decrease in the correct class target probability (q_{y}) of the target probability distribution q, and calibration is performed so that the smaller the probability value of the class estimate probability (p_{y}), the greater the increase in the false class target probability (q_{y}).

In FIG. 6, it can be seen that since the correct class estimate probability (p₄) has a large probability value, the calibrated correct class target probability (q′₄) has been greatly reduced. In addition, it can be seen that, among the probability values of the false class estimate probabilities (pⱼ) for the 1^{st} to 3^{rd} classes, the 1^{st} false class estimate probability (p₁) has the largest probability value, so it is calibrated so that the 1^{st} calibrated false class target probability (q′₁) has the smallest increase, whereas the 2^{nd} false class estimate probability (p₂) has the smallest probability value, so it is calibrated so that the 2^{nd} calibrated false class target probability (q′₂) has the largest increase.

That is, in the adaptive smoothing technique, calibration may be performed by subtracting a calibration value that increases in proportion to the probability value of the correct class estimate probability (p_{y}) from the correct class target probability (q_{y}), and subtracting a calibration value that increases in inverse proportion to the probability value of the false class estimate probability (pⱼ) from the false class target probability (qⱼ).

The adaptive smoothing technique can improve the efficiency of learning by adjusting the level of calibration for smoothing according to the correct class estimate probability (p_{y}) and the false class estimate probability (pⱼ) in the probability vector p, and can also train the artificial neural network model to perform operations suitable for actual reality. In the adaptive smoothing technique, smoothing can be performed by setting a smoothing function (f) in advance to perform calibration. However, in order to perform ideal calibration, the smoothing function (f) must be set so that it can linearly and accurately perform the required calibration according to the class-wise estimate probability (pⱼ) of the probability vector p (or the logit element (zⱼ) of the logit vector z).

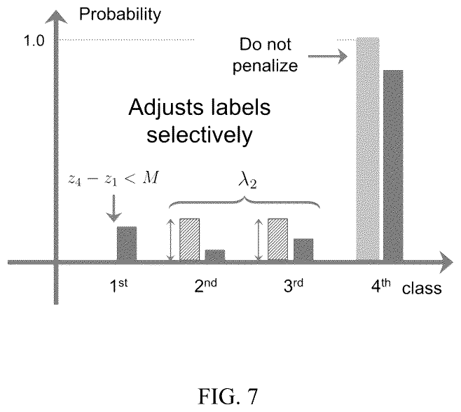

Meanwhile, the conditional smoothing technique illustrated in FIG. 7 is a technique that performs calibration according to a pre-set condition. In FIG. 7, an example is illustrated in which, in the conditional smoothing technique, smoothing is performed by adding a second conditional calibration value to the false class target probability (qⱼ), similar to the label smoothing technique, only when the difference in probability value between the false class estimate probability (pⱼ) and the false class target probability (qⱼ) is greater than or equal to a pre-defined margin value (M). As illustrated in FIG. 7, the conditional smoothing technique is a method in which calibration is conditionally performed only when the difference between the class-wise estimate probability (pⱼ) of the probability vector p and the class-wise target probability (qⱼ) of the target probability distribution q is greater than or equal to the margin value (M). Therefore, the efficiency can be improved by not performing calibration for the class-wise target probability (qⱼ) that does not require calibration. In FIG. 7, it is shown that the conditional smoothing technique is applied only to the false class target probability (qⱼ), but the conditional smoothing technique may also be applied to the correct class target probability (q_{y}). When the conditional smoothing technique is applied to the correct class target probability (q_{y}), smoothing may be performed by subtracting the first conditional calibration value (λ₁) from the correct class target probability (q_{y}), when the difference in probability value between the correct class estimate probability (q_{y}) and the correct class target probability (q_{y}) is greater than or equal to the margin value (M).

The above-mentioned label smoothing technique, adaptive smoothing technique, and conditional smoothing technique each have their own advantages and disadvantages, and therefore, in this disclosure, the above-mentioned label smoothing technique, adaptive smoothing technique, and conditional smoothing technique are all reflected to perform efficient smoothing. Here, this technique is called Adaptive and Conditional Label Smoothing (Hereinafter, ‘ACLS’).

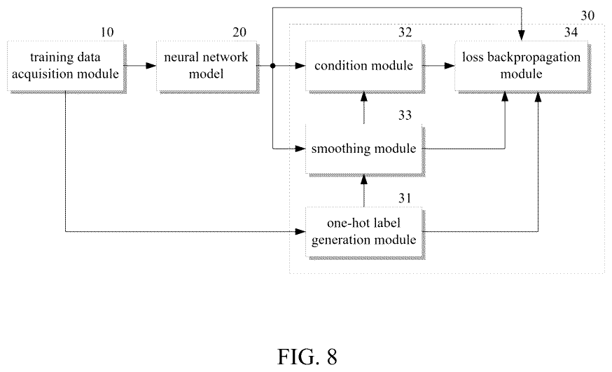

FIG. 8 shows a schematic configuration of a training device for a neural network model including an apparatus for calibrating confidence according to one embodiment.

Referring to FIG. 8, the training device for training a neural network model may include a training data acquisition module 10, a neural network model 20, and a training module 30.

The neural network model 20 is an artificial neural network model that is the target of training, and may be implemented as various artificial neural networks. The neural network model 20 may be a neural network model trained using a supervised learning method based on training data, and here, it is explained assuming that it is an image recognition neural network as an example.

The training data acquisition module 10 acquires a large amount of training data for training the neural network model 20. Here, the training data may be data labeled with ground truth, which are the result values that the neural network model must estimate.

The training module 30 is a configuration for training a neural network model based on training data acquired by the training data acquisition module 10. The training module 30 may train a neural network model by receiving the logit vector z and the probability vector p output from the neural network model 20 and backpropagating the loss using the ground truth labeled in the training data.

In particular, in the present disclosure, the training module 30 smoothes and calibrates the class-wise target probability (qⱼ) of the target probability distribution q obtained from the ground truth, and trains the neural network model based on the calibrated target probability distribution (q′) according to the calibrated class-wise target probability (q′ⱼ), thereby preventing the neural network model from making overconfident predictions.

The training module 30 may include a one-hot label generation module 31, a condition module 32, a smoothing module 33, and a loss backpropagation module 34.

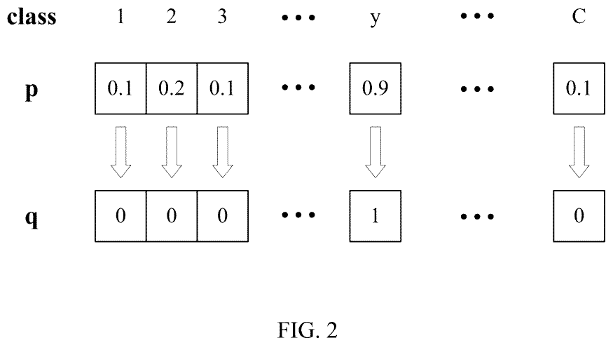

The one-hot label generation module 31 receives the ground truth labeled in the training data acquired by the training data acquisition module 10 and generates a target probability distribution q in the form of a one-hot label as shown in FIG. 2. In the target probability distribution q in the form of a one-hot label, a plurality of class-wise target probabilities (qⱼ) are configured as elements, and among the plurality of class-wise target probabilities (qⱼ), only the correct class target probability (q_{y}) corresponding to the correct class for the ground truth is configured to have a probability value of 1, and the false class target probabilities (qⱼ) for the remaining classes are configured to have a probability value of 0.

In the present disclosure, the condition module 32 distinguishes between a correct logit element (zⱼ, j=y) and false logit elements (zⱼ, j≠y) among a plurality of logit elements (zⱼ) of the logit vector z applied from the neural network model 20, based on the target probability distribution q in the form of a one-hot label generated by the one-hot label generation module 31, and compares the distinguished correct logit element (zⱼ, j=y) and false logit elements (zⱼ, j≠y) to determine whether to perform smoothing for each class target probability (qⱼ). The condition module 32 may set an indicator function ( [symbol] ^{(z}^{ⱼ₎}) that determines whether to perform smoothing, and input the plurality of logit elements (zⱼ) of the logit vector z to the set indicator function ( [symbol] ^{(z}^{ⱼ₎}) to determine whether to perform smoothing for each of the plurality of class-wise target probabilities (qⱼ) of the target probability distribution q.

Here, the indicator function ( [symbol] ^{(z}^{ⱼ₎}) can be set as in Equation 4.

$$ℂ ( {𝓏}_{j} ) = \{ \begin{matrix}[ {𝓏}_{j} - {min}_{k} {𝓏}_{k} \geq M ] , & j = y \\ [ {𝓏}_{y} - {𝓏}_{j} \geq M ] , & j \neq y\end{matrix} \qquad [ Equation 4 ]$$

wherein, [symbol] [·] is a function that outputs 1 if [·] is true and 0 if [·] is false, and M is the margin value.

According to the indicator function ( [symbol] ^{(z}^{ⱼ₎}) of Equation 4, the condition module 32 performs smoothing if the difference between the value of the correct logit element (z_{y}) for the correct class (j=y) and the value of the false logit element (zₖ) having the minimum value among the remaining false logit elements (zₖ, k≠y) is greater than or equal to the margin value (M).

In addition, for the false class (j≠y), if the difference between the value of the correct logit element (z_{y}) and the value of the false logit element (zⱼ) is greater than or equal to the margin value (M), smoothing is performed.

Using the indicator function ( [symbol] ^{(z}^{ⱼ₎}) of Equation 4 of the logit vector z, an indicator vector expressing as a value of 1 or 0 whether or not to smooth for each of the plurality of logit elements (zⱼ) may be generated and output to the loss backpropagation module 34.

The smoothing module 33 also, similarly to the conditional module 32, distinguishes between a correct logit element (zⱼ, j=y) and false logit elements (zⱼ, j≠y) among a plurality of logit elements (zⱼ) of the logit vector z applied from the neural network model 20, based on the target probability distribution q in the form of a one-hot label generated by the one-hot label generation module 31, and compares the distinguished correct logit element (zⱼ, j=y) and false logit elements (zⱼ, j≠y) to adjust the smoothing level for each class target probability (qⱼ).

The smoothing module 33 may set a smoothing function (f(zⱼ)) that adjusts the smoothing level, and input a plurality of logit elements (zⱼ) of the logit vector z into the set smoothing function (f(zⱼ)) to obtain a calibration value indicating the smoothing level for each of a plurality of class-wise target probabilities (qⱼ) of the target probability distribution q.

Here, the smoothing function (f(zⱼ)) can be set as in Equation 5.

$$f ( {𝓏}_{j} ) = \{ \begin{matrix}{λ}_{1} ( {𝓏}_{j} - {min}_{k} {𝓏}_{k} - M ] , & j = y \\ {λ}_{2} ( {𝓏}_{y} - {𝓏}_{j} - M ] , & j \neq y\end{matrix} \qquad [ Equation 5 ]$$

wherein, λ₁ and λ₂ are weights for adjusting the size ratio of the calibration values for adjusting the correct class target probability (q_{y}) and the false class target probability (qⱼ, j≠y), respectively, and M is a margin value.

According to the smoothing function (f(zⱼ)) of Equation 5, the smoothing module 33 may obtain a correct class calibration value by weighting the difference value, obtained by subtracting the value of the false logit element (zₖ) having the minimum value among the remaining false logit elements (zₖ, k≠y) and the margin value (M) from the value of the correct logit element (z_{y}), for the correct class (j=y), with a first weight (λ₁).

In addition, for the false class (j≠y), the false class calibration value may be obtained by weighting the difference value, obtained by subtracting the false logit element (zⱼ) and the margin value (M) from the correct logit element (z_{y}), with a second weight (λ₂).

Since the smoothing function (f(zⱼ)) is implemented as a linear function, the class target probability (qⱼ) may increase or decrease at a constant rate depending on the size of the plurality of logit elements (zⱼ).

Here, the condition module 32 and the smoothing module 33 do not consider the class target probability (qⱼ) of the target probability distribution q, because the probability values of the correct class target probability (q_{y}) and the false class target probability (qⱼ, j≠y) are 1 and 0, respectively, so the class target probability (qⱼ) is already reflected simply by distinguishing between the correct class (j=y) and the false class (j≠y).

The smoothing module 33 may generate a smoothing vector composed of calibration values for each class obtained by using the smoothing function (f(zⱼ)) of Equation 5 as elements, and output it to the loss backpropagation module 34.

The loss backpropagation module 34 calibrates the plurality of class target probabilities (qⱼ) of the target probability distribution q generated by the one-hot label generation module 31 based on the probability vector p obtained by the neural network model 20, the indicator vector obtained by the condition module 32, and the smoothing vector obtained by the smoothing module 33, and trains the neural network model 20 by backpropagating the gradient value of the loss corrected based on the calibrated class target probability (q′ⱼ) to the neural network model 20.

Since the loss backpropagation module 34 performs training using the calibrated class target probability (q′ⱼ) calibrated by smoothing, the loss backpropagation module 34 must consider not only the cross entropy loss (L_{ce}) but also the smoothing loss (L_{REG}) due to smoothing. Therefore, the total loss (L) can be expressed as Equation 6.

$$ℒ = {ℒ}_{CE} + {ℒ}_{REG} \qquad [ Equation 6 ]$$

In addition, since the gradient for the cross entropy loss (L_{ce}) is expressed as Equation 3, the gradient

$$\frac{\partial ℒ}{( \partial {𝓏}_{j} )}$$

for the total loss (L) of Equation 6 can be expressed as Equation 7.

$$\frac{\partial ℒ}{\partial {𝓏}_{j}} = {p}_{j} - {q}_{j} + \frac{\partial {ℒ}_{REG}}{\partial {𝓏}_{j}} \qquad [ Equation 7 ]$$

As described above, the loss backpropagation module 34 may perform smoothing based on the indication vector and the smoothing vector, and the indicator vector and the smoothing vector are applied separately for the correct class and the false class using the indicator function ( [symbol] ^{(z}^{ⱼ₎}) and the smoothing function (f(zⱼ)) shown in Equations 4 and 5, respectively, so Equation 7 can be re-expressed as Equation 8.

$$\frac{\partial ℒ}{\partial {𝓏}_{j}} = \{ \begin{matrix}{p}_{j} - ( {q}_{j} - f ( {𝓏}_{j} ) ℂ ( {𝓏}_{j} ) ) , & j = y \\ {p}_{j} - ( {q}_{j} + f ( {𝓏}_{j} ) ℂ ( {𝓏}_{j} ) ) , & j \neq y\end{matrix} \qquad [ Equation 8 ]$$

The loss backpropagation module 34 may calculate the gradient

$$\frac{\partial ℒ}{( \partial {𝓏}_{j} )}$$

for the loss (L) using the probability vector p, the target probability distribution q, and the indicator vector and the smoothing vector, and backpropagate it.

In addition, since the indicator function ( [symbol] ^{(z}^{ⱼ₎}) and the smoothing function (f(zⱼ)) in Equation 8 are functions according to Equations 4 and 5, the gradient

$$\frac{\partial ℒ}{( \partial {𝓏}_{j} )}$$

for the loss (L) of Equation 8 can be organized into Equation 9.

$$\frac{\partial ℒ}{\partial {𝓏}_{j}} = \{ \begin{matrix}{λ}_{1} ReLU ( {𝓏}_{j} - {min}_{k} {𝓏}_{k} - M ) , & j = y \\ {λ}_{2} ReLU ( {𝓏}_{y} - {𝓏}_{j} - M ) , & j \neq y\end{matrix} \qquad [ Equation 9 ]$$

wherein, ReLU (·) represents the rectified linear unit function.

Referring to equation 9, the loss backpropagation module 34 may obtain the gradient

$$\frac{\partial ℒ}{( \partial {𝓏}_{j} )}$$

of the loss (L) by weighting the calculated difference value with a first weight (λ₁), when the difference value obtained by subtracting the margin value (M) and the false logit element (zₖ) having the minimum value among the remaining false logit elements (zₖ, k≠y) from the value of the correct logit element (z_{y}), for the correct class (j=y), is a positive value.

In addition, for the false class (j≠y), when the difference value, obtained by subtracting the false logit element (zⱼ) and the margin value (M) from the correct logit element (z_{y}), is a positive value, the gradient

$$\frac{\partial ℒ}{( \partial {𝓏}_{j} )}$$

of the loss (L) may be obtained by weighting the calculated difference value with a negative second weight (−λ₂).

The loss backpropagation module 34 may train the neural network model 20 to prevent overconfidence prediction by backpropagating the gradient

$$\frac{\partial ℒ}{( \partial {𝓏}_{j} )}$$

of the loss (L) obtained according to Equation 9 to the neural network model 20.

Here, the loss (L) can be expressed by Equation 10.

$$\frac{\partial ℒ}{\partial {𝓏}_{j}} = \{ \begin{matrix}{{λ}_{1} ( ReLU ( {𝓏}_{j} - {min}_{k} {𝓏}_{k} - M ) )}^{2} , & j = y \\ {{λ}_{2} ( ReLU ( {𝓏}_{y} - {𝓏}_{j} - M ) )}^{2} , & j \neq y\end{matrix} \qquad [ Equation 10 ]$$

However, since the loss backpropagation module 34 performs training by backpropagating the gradient

$$\frac{\partial ℒ}{( \partial {𝓏}_{j} )}$$

of the loss (L) to the neural network model 20, the loss (L) may not be calculated.

In the above-described configuration, the condition module 32, the smoothing module 33, and the loss backpropagation module 34 can be seen as operating as an apparatus for calibrating confidence. For the convenience of understanding, the condition module 32, the smoothing module 33, and the loss backpropagation module 34 in which the training module 30 operates are illustrated separately. However, since the loss backpropagation module 34 obtains the gradient

$$\frac{\partial ℒ}{( \partial {𝓏}_{j} )}$$

of the loss (L) according to Equation 9 and backpropagates it, the condition module 32 and the smoothing module 33 may be omitted. Here, for the convenience of understanding, the one-hot label generation module 31 is described as generating a target probability distribution q in the form of a one-hot label based on the ground truth applied from the training data acquisition module 10, but in many cases, the training data acquisition module 10 already transmits the ground truth in the form of a one-hot label. Therefore, the one-hot label generation module 31 may also be omitted. That is, the training module 30 including the one-hot label generation module 31, the condition module 32, the smoothing module 33, and the loss backpropagation module 34 can be called an apparatus for calibrating confidence.

In the illustrated embodiment, respective configurations may have different functions and capabilities in addition to those described above, and may include additional configurations in addition to those described above. In addition, in an embodiment, each configuration may be implemented using one or more physically separated devices, or may be implemented by one or more processors or a combination of one or more processors and software, and may not be clearly distinguished in specific operations unlike the illustrated example.

In addition, the apparatus for calibrating confidence shown in FIG. 8 may be implemented in a logic circuit by hardware, firm ware, software, or a combination thereof or may be implemented using a general purpose or special purpose computer. The apparatus may be implemented using hardwired device, field programmable gate array (FPGA) or application specific integrated circuit (ASIC). Further, the apparatus may be implemented by a system on chip (SoC) including one or more processors and a controller.

In addition, the apparatus for calibrating confidence may be mounted in a computing device or server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

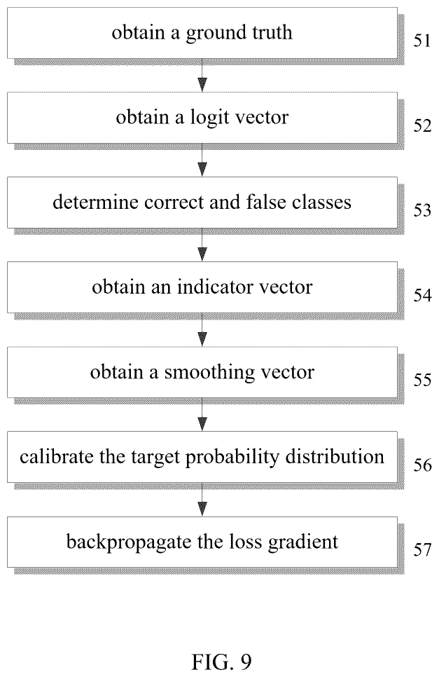

FIG. 9 shows a method for calibrating confidence according to one embodiment.

Referring to FIG. 9, the method for calibrating confidence first obtains a ground truth labeled in the training data (51). Here, the ground truth may be obtained as a target probability distribution q in the form of a one-hot label, where a correct target probability (q_{y}) with a probability value of 1 is placed for the correct class, and a false target probability (qⱼ) with a probability value of 0 is placed for the remaining false classes, or a target probability distribution q in the form of a one-hot label may be generated from the obtained ground truth.

Once the target probability distribution q is obtained, the training data is input into the neural network model 20 that is the target of training, and the neural network model 20 obtains a logit vector z that encodes the training data (52). Here, the logit vector z is composed of a plurality of logit elements (zⱼ) that have values according to each class.

Once a logit vector z composed of a plurality of logit elements (zⱼ) is obtained, it is determined whether each logit element (zⱼ) is a correct logit element (z_{y}) for the correct class or a false logit element (zⱼ) for the false class according to a plurality of target probabilities (qᵢ), which are elements of the target probability distribution q (53).

Once the correct logit element (z_{y}) and the false logit element (zⱼ) are distinguished, as in Equation 4, an indicator vector is obtained that indicates whether to perform calibration, i.e. smoothing, for the target probability (qⱼ) of the target probability distribution q according to the difference in the values of the correct logit element (z_{y}) and the false logit element (zⱼ) (54).

Here, the indicator vector may be generated so as to instruct that, for the correct class (j=y), smoothing is to be performed when the difference between the value of the correct logit element (z_{y}) and the value of the false logit element (zₖ) having the minimum value among the remaining false logit elements (zₖ, k≠y) is greater than or equal to the margin value (M), and that, for the false class (j≠y), smoothing is to be performed when the difference between the value of the correct logit element (z_{y}) and the value of the false logit element (zⱼ) is greater than or equal to the margin value (M).

Meanwhile, once the correct logit element (z_{y}) and the false logit elements (zⱼ) are distinguished, a smoothing vector consisting of calibration values representing the smoothing level of the target probability (qⱼ) of the target probability distribution q is obtained according to the difference in the values of the correct logit element (z_{y}) and the false logit element (zⱼ), as in Equation 5 (55).

In the smoothing vector, the calibration value for the correct class (j=y) may be obtained by weighting the difference value, obtained by subtracting the false logit element (zₖ) with the minimum value among the remaining false logit elements (zₖ, k≠y) and the margin value (M) from the value of the correct logit element (z_{y}), with a first weight (λ₁), and the calibration value for the false class (j≠y) may be obtained by weighting the difference value, obtained by subtracting the false logit element (zⱼ) and the margin value (M) from the correct logit element (z_{y}), with a second weight (λ₂).

Once the indicator vector and the smoothing vector are obtained, a plurality of target probabilities (qⱼ) of the target probability distribution q are calibrated according to the obtained indicator vector and smoothing vector (56). At this time, only the target probability (qⱼ) specified by the indicator vector among the plurality of target probabilities (qⱼ) may be calibrated, and the target probability specified by the indicator vector may be calibrated by increasing or decreasing by the size specified by the smoothing vector. The smoothing vector may be set to subtract from the correct class target probability (q_{y}) while increasing from the false class target probability (qⱼ).

Once the target probability distribution q is calibrated to obtain the calibrated target probability distribution (q′), the neural network model 20 calculates the gradient

$$\frac{\partial ℒ}{( \partial {𝓏}_{j} )}$$

of the loss (L) based on the difference between the probability vector p obtained from the logit vector z and the elements (pⱼ, qⱼ) of the calibrated target probability distribution (q′), and trains the neural network model 20 by backpropagating the calculated gradient

$$\frac{\partial ℒ}{( \partial {𝓏}_{j} )}$$

of the loss (L) (57).

In the above, it was explained that the indicator vector and smoothing vector for calibrating the target probability distribution q are first obtained, and the target probability distribution q is first calibrated based on the obtained indicator vector and smoothing vector, and then the gradient

$$\frac{\partial ℒ}{( \partial {𝓏}_{j} )}$$

of the loss (L) is calculated based on the calibrated target probability distribution (q′).

However, as shown in Equation 9, the gradient

$$\frac{\partial ℒ}{( \partial {𝓏}_{j} )}$$

of the loss (L) can also be directly calculated and obtained in a manner in which the calculated target probability distribution (q′) is reflected from the logit vector z, without first calculating the calculated target probability distribution (q′).

Here, the gradient

$$\frac{\partial ℒ}{( \partial {𝓏}_{j} )}$$

of the loss (L) reflecting the calculated target probability distribution (q′) can be obtained, for the correct class (j=y), by weighting the calculated difference value with the first weight (λ₁) when the difference value, obtained by subtracting the false logit element (zₖ) having the minimum value among the remaining false logit elements (zₖ, k≠y) and the margin value (M) from the value of the correct logit element (z_{y}), is a positive value.

In addition, for the false class (j≠y), when the difference value, obtained by subtracting the false logit element (zⱼ) and the margin value (M) from the correct logit element (z_{y}), is a positive value, it can be obtained by weighting the calculated difference value with the negative second weight (−λ₂).

In FIG. 9, it is described that respective processes are sequentially executed, which is, however, illustrative, and those skilled in the art may apply various modifications and changes by changing the order illustrated in FIG. 9 or performing one or more processes in parallel or adding another process without departing from the essential gist of the exemplary embodiment of the present disclosure.

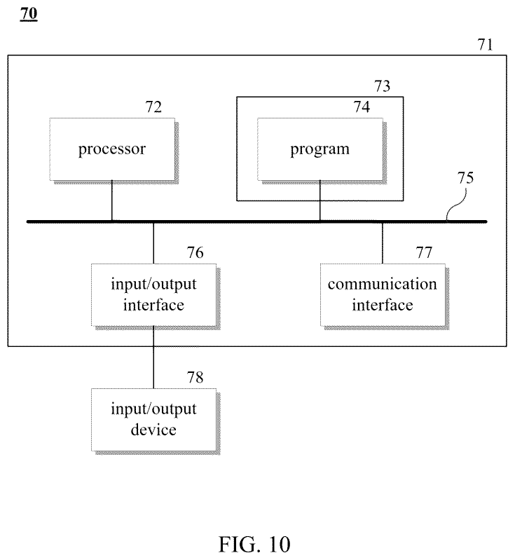

FIG. 10 is a drawing for explaining a computing environment including a computing device according to one embodiment.

In the illustrated embodiment, respective configurations may have different functions and capabilities in addition to those described below, and may include additional configurations in addition to those described below. The illustrated computing environment 70 may include a computing device 71 to perform the method for calibrating confidence illustrated in FIG. 10. In an embodiment, the computing device 71 may be one or more components included in the apparatus for calibrating confidence shown in FIG. 8.

The computing device 71 includes at least one processor 72, a computer readable storage medium 73 and a communication bus 75. The processor 72 may cause the computing device 71 to operate according to the above-mentioned exemplary embodiment. For example, the processor 72 may execute one or more programs 74 stored in the computer readable storage medium 73. The one or more programs 74 may include one or more computer executable instructions, and the computer executable instructions may be configured, when executed by the processor 72, to cause the computing device 71 to perform operations in accordance with the exemplary embodiment.

The communication bus 75 interconnects various other components of the computing device 71, including the processor 72 and the computer readable storage medium 73.

The computing device 71 may also include one or more input/output interfaces 76 and one or more communication interfaces 77 that provide interfaces for one or more input/output devices 78. The input/output interfaces 76 and the communication interfaces 77 are connected to the communication bus 75. The input/output devices 78 may be connected to other components of the computing device 71 through the input/output interface 76. Exemplary input/output devices 78 may include input devices such as a pointing device (such as a mouse or trackpad), keyboard, touch input device (such as a touchpad or touchscreen), voice or sound input device, sensor devices of various types and/or photography devices, and/or output devices such as a display device, printer, speaker and/or network card. The exemplary input/output device 78 is one component constituting the computing device 71, may be included inside the computing device 71, or may be connected to the computing device 71 as a separate device distinct from the computing device 71.

The present disclosure has been described in detail through a representative embodiment, but those of ordinary skill in the art to which the art pertains will appreciate that various modifications and other equivalent embodiments are possible from this. Therefore, the true technical protection scope of the present invention should be determined by the technical spirit set forth in the appended scope of claims.

What is claimed is:

1. An apparatus for calibrating confidence, comprising:
a memory; and a processor that executes at least a part of an operation according to a program stored in the memory,
wherein the processor
determines a correct logit element and a false logit element among a plurality of logit elements of a logit vector obtained by a neural network model performing a neural network operation on training data, based on a correct class and a false class determined from a target probability distribution including target probabilities for each of a plurality of classes according to ground truth of the training data as elements, and
determines whether to calibrate and a calibration value for a plurality of target probabilities of the target probability distribution based on a difference in value between the correct logit element and the false logit element.

2. The apparatus for calibrating confidence according to claim 1,
wherein the processor performs calibration, for the correct class, when the value, obtained by subtracting the value of the false logit element having the minimum value among remaining false logit elements from the value of the correct logit element, is greater than or equal to a margin value.

3. The apparatus for calibrating confidence according to claim 1,
wherein the processor performs calibration on the false logit element, when the value, obtained by subtracting the value of each false logit element from the value of the correct logit element, for the false class, is greater than or equal to a margin value.

4. The apparatus for calibrating confidence according to claim 1,
wherein the processor obtains a correct calibration value by weighting the difference in value, obtained by subtracting a margin value and the false logit element having the minimum value among remaining false logit elements from the value of the correct logit element, for the correct class, with a first weight.

5. The apparatus for calibrating confidence according to claim 4,
wherein the processor performs calibration, when it is determined that the calibration is being performed for the correct class, by subtracting the correct calibration value determined from a correct target probability among the plurality of target probabilities of the target probability distribution.

6. The apparatus for calibrating confidence according to claim 1,
wherein the processor obtains a false calibration value by weighting the difference in value, obtained by subtracting the value of each false logit element and a margin value from the value of the correct logit element, for the false class, with a second weight.

7. The apparatus for calibrating confidence according to claim 6,
wherein the processor performs calibration, when it is determined that the calibration is being performed for the false class, by adding the false calibration value determined from a false target probability among the plurality of target probabilities of the target probability distribution.

8. The apparatus for calibrating confidence according to claim 1,
wherein the processor calculates a gradient of loss for training the neural network model, by weighting the calculated difference in value with a first weight, when the difference in value, obtained by subtracting a margin value and the value of the false logit element having the minimum value among remaining false logit elements from the value of the correct logit element, for the correct class, is a positive value.

9. The apparatus for calibrating confidence according to claim 1,
wherein the processor calculates a gradient of loss for training the neural network model, by weighting the calculated difference in value with a negative second weight, when the difference in value, obtained by subtracting a margin value and the value of each false logit element from the value of the correct logit element, for the false class, is a positive value.

10. The apparatus for calibrating confidence according to claim 1,
wherein the target probability distribution is configured in a one-hot label format where a target probability for the correct class has a probability value of 1 and a target probability for the false class has a probability value of 0.

11. A method for calibrating confidence performed by a processor, the method comprising the steps of:
determining a correct logit element and a false logit element among a plurality of logit elements of a logit vector obtained by a neural network model performing a neural network operation on training data, based on a correct class and a false class determined from a target probability distribution including target probabilities for each of a plurality of classes according to ground truth of the training data as elements; and
determining whether to calibrate and a calibration value for a plurality of target probabilities of the target probability distribution based on a difference in value between the correct logit element and the false logit element.

12. The method for calibrating confidence according to claim 11,
wherein the step of determining the calibration value includes
performing calibration, for the correct class, when the value, obtained by subtracting the value of the false logit element having the minimum value among remaining false logit elements from the value of the correct logit element, is greater than or equal to a margin value.

13. The method for calibrating confidence according to claim 11,
wherein the step of determining the calibration value includes
performing calibration on the false logit element, when the value, obtained by subtracting the value of each false logit element from the value of the correct logit element, for the false class, is greater than or equal to a margin value.

14. The method for calibrating confidence according to claim 11,
wherein the step of determining the calibration value includes
obtaining a correct calibration value by weighting the difference in value, obtained by subtracting a margin value and the false logit element having the minimum value among remaining false logit elements from the value of the correct logit element, for the correct class, with a first weight.

15. The method for calibrating confidence according to claim 14,
wherein the step of determining the calibration value includes
performing calibration, when it is determined that calibration is being performed for the correct class, by subtracting the correct calibration value determined from a correct target probability among the plurality of target probabilities of the target probability distribution.

16. The method for calibrating confidence according to claim 11,
wherein the step of determining the calibration value includes
obtaining a false calibration value by weighting the difference in value, obtained by subtracting the value of each false logit element and a margin value from the value of the correct logit element, for the false class, with a second weight.

17. The method for calibrating confidence according to claim 16,
wherein the step of determining the calibration value includes
performing calibration, when it is determined that calibration is being performed for the false class, by adding the false calibration value determined from a false target probability among the plurality of target probabilities of the target probability distribution.

18. The method for calibrating confidence according to claim 11,
wherein the step of determining the calibration value includes
calculating a gradient of loss for training the neural network model, by weighting the calculated difference in value with a first weight, when the difference in value, obtained by subtracting a margin value and the value of the false logit element having the minimum value among the remaining false logit elements from the value of the correct logit element, for the correct class, is a positive value.

19. The method for calibrating confidence according to claim 11,
wherein the step of determining the calibration value includes
calculating a gradient of loss for training the neural network model, by weighting the calculated difference in value with a negative second weight, when the difference in value, obtained by subtracting a margin value and the value of each false logit element from the value of the correct logit element, for the false class, is a positive value.

20. The method for calibrating confidence according to claim 11,
wherein the target probability distribution is configured in a one-hot label format where a target probability for the correct class has a probability value of 1 and a target probability for the false class has a probability value of 0.
